(19) United States
(12) Patent Application Publication
(10) Pub. No.: US 2018/0097886 A1
(43) Pub. Date: Apr. 5, 2018

(54) SENSOR NETWORK SYSTEM

(71) Applicant: NEC Corporation, Tokyo (JP)

(72) Inventor: Tetsuo INOUE, Tokyo (JP)

(73) Assignee: NEC Corporation, Tokyo (JP)

(21) Appl. No.: 15/560,183

(22) PCT Filed: Dec. 28, 2015
(86) PCT No.: PCT/JP2015/006494

§ 371 Date: Sep. 21, 2017

(30) Foreign Application Priority Data
Mar. 27, 2015 (JP) 2015-066400

(51) Int. Cl. H04L 29/08; H04W 4/00; G06F 17/30; H04W 84/18

(52) U.S. Cl. CPC H04L 67/12; H04W 4/006; H04L 67/10; H04W 84/18; G06F 17/3005

(57) ABSTRACT

A sensor network system includes a platform device, a relay server, a plurality of sensor terminals, and a user terminal. The platform device has a user command processing part configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

### TECHNICAL FIELD

The present invention relates to a sensor network system, a platform device and a method thereby, and a program.

### BACKGROUND ART

As the Internet has become broad-band and low-price and wireless communication equipment has become small-sized, a sensor network system that obtains sensing data in real time from a number of geographically distributed sensor terminals and provides various services has been proposed and in practical use.

For example, a sensor network system that has a M2M server, a M2M gateway connected to the M2M server via a network such as the Internet, a sensor terminal (a M2M device) connected to the M2M gateway via a network such as ZigBee and a console connected to the M2M server is proposed as a first related technique that relates to the present invention (see Patent Document 1, for example).

According to the first related technique, the M2M gateway obtains sensor list information indicating a list of the connected sensor terminals and transmits the list to the M2M server, and the M2M server displays the sensor list information on the screen of the console. The sensor list information includes a sensor terminal ID (an ID that uniquely identifies a sensor on the sensor network system) and one or more items of supplementary information. In the first related technique, supplementary information such as a sensor type (a type such as a thermometer or a hygrometer), a data type and a unit is used.

The user of the sensor network system creates sensor transmission instruction information on the basis of the sensor list information displayed on the screen. The sensor transmission instruction information includes items such as the sensor terminal ID and a sensor data transmission instruction. When the user transmits the sensor transmission instruction information to the MSM server, the M2M server transfers the sensor transmission instruction information to the M2M gateway. In accordance with the received sensor transmission instruction information, the M2M gateway obtains sensing data from the sensor terminal and transmits the sensing data to the M2M server, and the sensing data is stored on the M2M server. After that, in accordance with the object of an application, the sensing data on the M2M server is analyzed.

On the other hand, it is proposed as a second related technique relating to the present invention that a server device calculates a feature (a maximum value, an average value, or the like) of sensing data during a predetermined period for each sensor terminal previously given by the user and keeps the feature in association with the sensing data and, when a search request with a sensor terminal ID and a feature set as search conditions is input by the user of the system, searches for sensing data that has the designated sensor terminal ID and a feature agreeing with the designated feature (see Patent Document 2, for example).

Patent Document 1: Japanese Unexamined Patent Application Publication No. JP-A 2014-068285
Patent Document 2: Japanese Unexamined Patent Application Publication No. JP-A 2011-221799

In general, in a sensor network system, when searching for desired sensing data from a number of stored sensing data, it is required to designate a sensor terminal ID as a search condition as shown in the second related technique relating to the present invention. Therefore, when the ID of a sensor from which the user wants to obtain sensing data is unknown, it is impossible to search.

In the first related technique relating to the present invention, sensor list information including a sensor ID and one or more supplementary information is acquired from a sensor terminal and transmitted to the M2M server by the M2M gateway, and is displayed on the screen of the console connected to the M2M server. Therefore, by checking the sensor list information, the user can find the ID of a sensor terminal having desired supplementary information. However, it is not easy for the user to find a sensor terminal having desired supplementary information from the sensor list information shown on the screen describing information about a number of sensor terminals.

### SUMMARY

An object of the present invention is to provide a sensor network system which solves the abovementioned problem, namely, a problem that it is impossible to search when identification information of a sensor terminal from which the user wants to obtain sensing data is unknown and it is difficult to find a sensor terminal having desired supplementary information.

A sensor network system as an aspect of the present invention is a sensor network system includes: a platform device; a plurality of sensor terminals connected to the platform device via a relay server; and a user terminal connected to the platform device.

The platform device includes a user command processing part configured to: receive, from the user terminal, a search request including supplementary information of the sensor terminal as a search condition; in accordance with the search request, search a database in which supplementary information of the sensor terminals, sensing data sensed by the sensor terminals and identification information of the sensor terminals are associated and stored; and output a search result to the user terminal.

A platform device as another aspect of the present invention is a platform device connected to a relay server and a user terminal. A plurality of sensor terminals are connected to the relay server.

The platform device includes a user command processing part configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

A method as another aspect of the present invention is a method executed by a platform device connected to a relay server and a user terminal. A plurality of sensor terminals are connected to the relay server.

The method includes: receiving, from the user terminal, a search request including supplementary information of the sensor terminal as a search condition; searching, in accordance with the search request, a database in which supplementary information of the sensor terminals, sensing data sensed by the sensor terminals, and identification information of the sensor terminals are associated and stored; and outputting a search result to the user terminal.

A computer program as another aspect of the present invention includes instructions for causing a computer to function as a user command processing part. The computer is connected to a relay server and a user terminal. A plurality of sensor terminals are connected to the relay server.

The user command processing part is configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

With the configurations described above, the present invention allows the user to search even when identification information of a sensor terminal from which the user wants to obtain sensor data is unknown and also allows the user to find a sensor terminal having desired supplementary information.

### BRIEF DESCRIPTION OF DRAWINGS

FIG. 1 is a block diagram of a sensor network system according to a first exemplary embodiment of the present invention;

FIG. 2 is a diagram showing an example of a format of sensor terminal basic information;

FIG. 3 is a diagram showing an example of a format of sensor data;

FIG. 4 is a flowchart showing an example of an operation of a platform device in the first exemplary embodiment of the present invention;

FIG. 5 is a diagram showing an example of a format of a search request in the first exemplary embodiment of the present invention;

FIG. 6 is a diagram showing another example of a format of a search request in the first exemplary embodiment of the present invention;

FIG. 7 is a block diagram of a sensor network system according to a second exemplary embodiment of the present invention;

FIG. 8 is a specific block diagram of the sensor network system according to the second exemplary embodiment of the present invention;

FIG. 9 is a diagram showing a procedure for connecting a M2M device in the second exemplary embodiment of the present invention;

FIG. 10 is a diagram showing a procedure for notifying sensing information to a platform by the M2M device in the second exemplary embodiment of the present invention;

FIG. 11 is a diagram showing a procedure for obtaining sensing information of the M2M device by a user terminal in the second exemplary embodiment of the present invention;

FIG. 12 is a flowchart showing an operation of a user command processing function in the second exemplary embodiment of the present invention;

FIG. 13 is a flowchart showing an operation of a database function in the second exemplary embodiment of the present invention;

FIG. 14 is a flowchart showing an operation of a search result processing function in the second exemplary embodiment of the present invention;

FIG. 15 is a block diagram of a sensor network system according to a third exemplary embodiment of the present invention;

FIG. 16 is a diagram showing an example of a search result displayed on a screen of a user terminal in the third exemplary embodiment of the present invention;

FIG. 17 is a block diagram of a sensor network system relating to the present invention;

FIG. 18 is a block diagram of a sensor network system according to a fourth exemplary embodiment of the present invention;

FIG. 19 is a flowchart showing an example of an operation of a platform device in a fourth exemplary embodiment of the present invention;

FIG. 20 is a block diagram of a sensor network system according to a fifth exemplary embodiment of the present invention; and

FIG. 21 is a flowchart showing an example of an operation of a platform device in the fifth exemplary embodiment of the present invention.

### EXEMPLARY EMBODIMENTS

Next, exemplary embodiments of the present invention will be described in detail with reference to the drawings.

### First Exemplary Embodiment

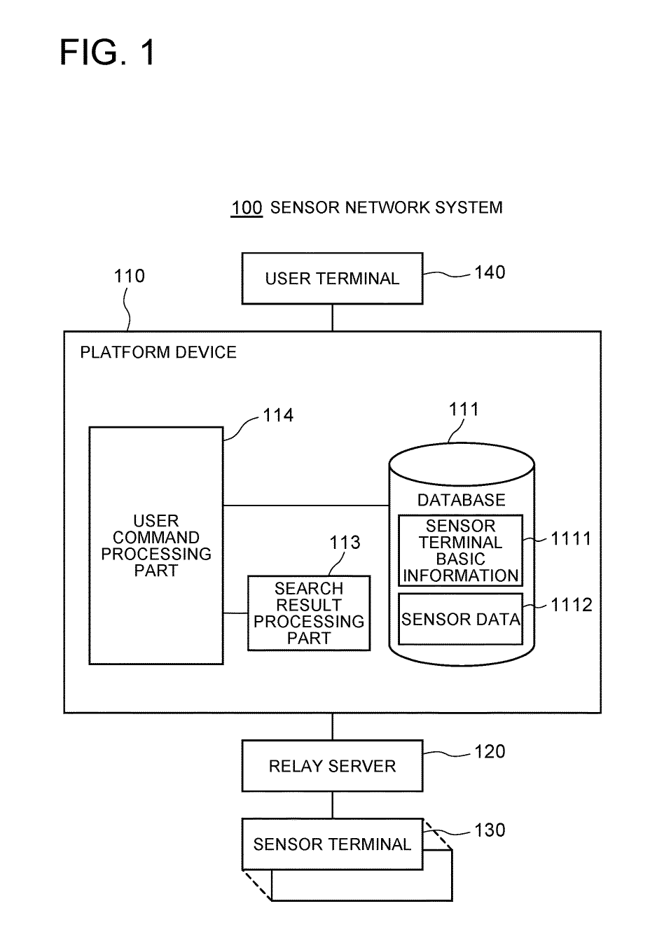

With reference to FIG. 1, a sensor network system 100 according to a first exemplary embodiment of the present invention includes a platform device 110, a relay server 120, a plurality of sensor terminals 130 connected to the platform device 110 via the relay server 120, and a user terminal 140 connected to the platform device 110. FIG. 1 depicts a single user terminal 140 and a single relay server 120, but may depict a plurality of user terminals 140 and a plurality of relay servers 120.

Further, the platform device 110 has a database 111, a search result processing part 113, and a user command processing part 114.

The database 111 has a function to associate and keep supplementary information of the sensor terminal 130, sensing data sensed by the sensor terminal 130, and identification information of the sensor terminal 130 (referred to as a sensor terminal ID hereinafter). Supplementary information is information relating to a sensor terminal excluding a sensor terminal ID and sensing data. For example, information of the type, specification, attribute, manager's name, installation place and so on of the sensor terminal 130 are supplementary information, respectively. A configuration to associate and store supplementary information of a sensor terminal, sensing data and a sensor terminal ID in the database 111 can be any configuration. In FIG. 1, as an example, supplementary information of a sensor terminal, sensing data, and a sensor terminal ID are associated by using two kinds of data including sensor terminal basic information 1111 and sensor data 1112. However, supplementary information of a sensor terminal, sensing data, and a sensor terminal ID may be associated and stored by using one kind of data or three or more kinds of data.

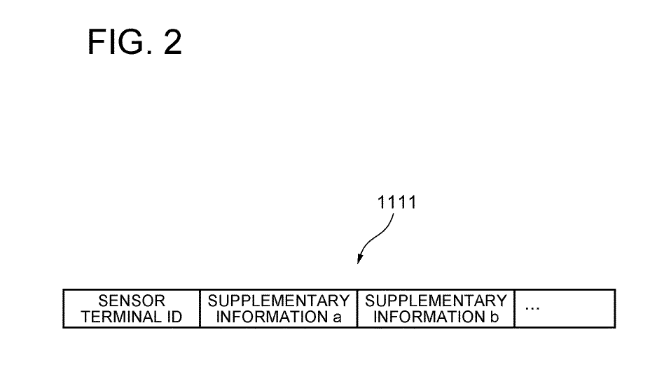

The sensor terminal basic information 1111 includes a sensor terminal ID and supplementary information of the sensor terminal 130. The sensor terminal basic information 1111 is present for each of the sensor terminals 130. FIG. 2 shows an example of a format of the sensor terminal basic information 1111. The sensor terminal basic information 1111 in this example includes a sensor terminal ID and a plurality of supplementary information.

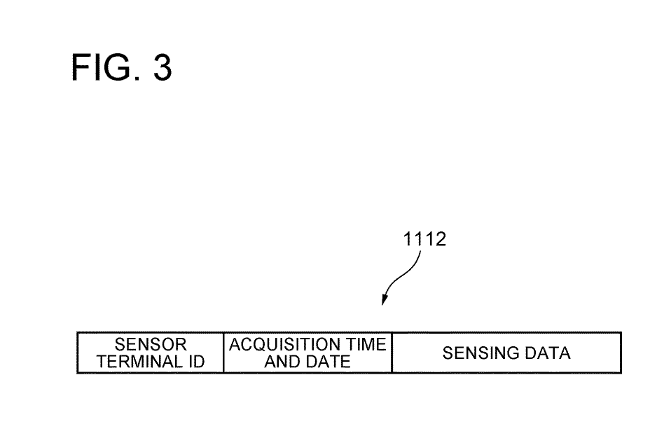

The sensor data 1112 includes a sensor terminal ID and data sensed by the sensor terminal 130. The sensor data 1112 is present for each sensing data of the sensor terminal 130. FIG. 3 shows an example of the sensor data 1112. The sensor data 1112 in this example includes a sensor terminal ID, an acquisition time and date, and sensing data. Sensing data is data obtained by a sensor included by the sensor terminal 130, and the kind and unit of the data. The kind and unit of data may be included by the supplementary information. For example, in a case where the sensor is a thermometer or a barometer, sensing data is temperature or barometric pressure. In a case where the sensor is a security camera, sensing data is image data captured and obtained by the security camera. An acquisition time and date is time and date when the sensing data has been obtained.

The user command processing part 114 has a function to receive a search request including a search condition and a process condition input from the user terminal 140. A search condition designates one or more supplementary information. A process condition designates a process that should be executed on the basis of sensing data of a search result.

Further, the user command processing part 114 has a function to search the database 111 for the ID and sensing data of a sensor terminal having supplementary information agreeing with the search condition included by the search request. To be specific, the user command processing part 114 searches the database 111 for the sensor terminal basic information 1111 including supplementary information agreeing with supplementary information designated as the search condition, and subsequently searches the database 111 for the sensor data 1112 including a sensor terminal ID agreeing with a sensor terminal ID included by the searched and obtained sensor terminal basic information 1111, and then obtains sensing data included by the searched and obtained sensor data 1112 and the sensor terminal ID.

Further, the user command processing part 114 has a function to notify the search result and the process condition included by the search request to the search result processing part 113 and output the execution result received from the search result processing part 113 as a search result to the user terminal 140. Moreover, in a case where the most recent sensing data is needed for executing a process corresponding to the process condition, the user command processing part 114 obtains the most recent sensing data from the sensor terminal 130 via the relay server 120 and notifies the search result with the most recent sensing data included to the search result processing part 113.

The search result processing part 113 has a function to, when a search result and a process condition are notified by the user command processing part 114, execute a process designated by the process condition on the basis of sensing data of the search result and return the result of execution of the process to the user command processing part 114.

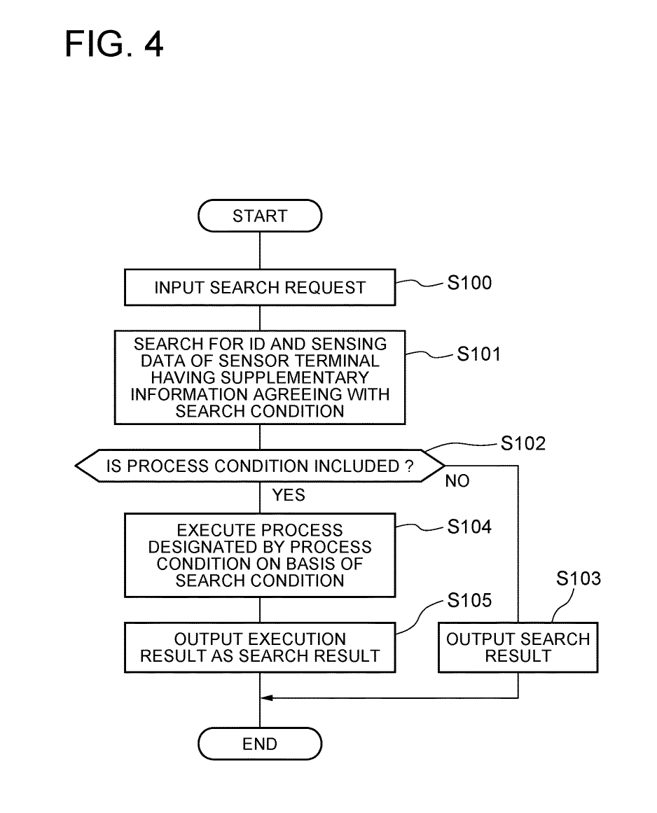

FIG. 4 is a flowchart showing an example of an operation of the platform device 110. Below, the operation in this exemplary embodiment will be described with reference to FIG. 4.

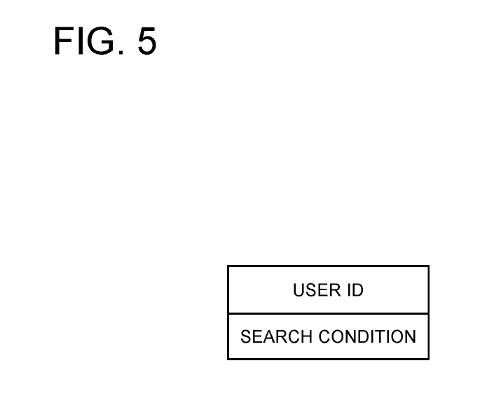

When the user of the user terminal 140 wants to obtain sensing data of the sensor terminal 130 having desired supplementary information, the user transmits a search request in which the desired supplementary information is set as a search condition from the user terminal 140 to the platform device 110. FIG. 5 shows an example of such a search request. The search request in this example includes the ID of the user terminal 140 and a search condition.

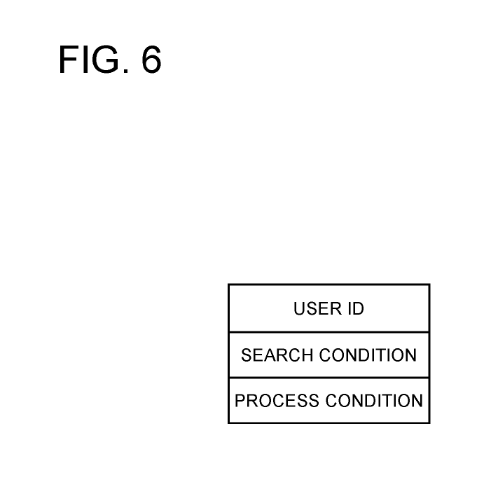

Further, when the user of the user terminal 140 wants to execute a specific process on the basis of sensing data of the sensor terminal 130 having desired supplementary information, the user transmits a search request in which the desired supplementary information is set as a search condition and the specific process is set as a process condition from the user terminal 140 to the platform device 110. FIG. 6 shows an example of such a search request. The search request in this example includes the ID of the user terminal 140, a search condition, and a process condition. The search condition and the process condition may be referred to as a first designated condition and a second designated condition, respectively.

Upon receiving a search request from the user terminal 140 (step S100), the user command processing part 114 of the platform device 110 searches the database 111 for the ID and sensing data of the sensor terminal 130 having supplementary information agreeing with a search condition included by the search request (step S101).

Next, the user command processing part 114 determines whether a process condition is included by the search request (step S102). In a case where a process condition is not included by the search request, that is, the search request is as shown in FIG. 5, the user command processing part 114 transmits, to the user terminal 140, a search result showing the ID and sensing data of the sensor terminal searched and obtained at step S101 (step S103). Upon receiving the search result from the platform device 110, the user terminal 140 displays the search result on the screen of the user terminal 140.

Further, in a case where a process condition is included by the search request, that is, the search request is as shown in FIG. 6, the user command processing part 114 causes the search result processing part 113 to execute a process designated by the process condition included by the search request on the basis of the ID and sensing data of the sensor terminal searched and obtained at step S101 (step S104). In a case where the most recent sensing data of the sensor terminal is needed for executing the process corresponding to the process condition, the user command processing part 114 obtains the most recent sensing data from the sensor terminal 130 via the relay server 120 and supplies the most recent sensing data to the search result processing part 113.

Next, the user command processing part 114 transmits the result of execution by the search result processing part 113 as a search result to the user terminal 140 (step S105). Upon receiving the search result from the platform device 110, the user terminal 140 displays the search result on the screen of the user terminal 140.

Next, an example of a process condition will be described.

### Example 1

As a process condition, a process condition that a search result is sorted by a specific sorting method may be set. In this case, the search result processing part 113 generates, as a search result, a result obtained by sorting sensor terminal IDs and sensing data searched and obtained at step S101 by the specific sorting method. In a case where a plurality of results are contained in the search result, it is general that the plurality of results are sorted by a sorting method determined by the system and output to the user terminal 140. However, according to this exemplary embodiment, a sorting method can be set as a process condition, so that the user can obtain a search result sorted by a sorting method appropriate for himself/herself.

### Example 2

As a process condition, a process condition that a sensor type 1 and a sensor type 2 are designated, the total value of the most recent sensing data of all the sensor terminals of the sensor type 1 (i.e., a first total value) is calculated, the total value of the most recent sensing data of all the sensor terminals of the sensor type 2 (i.e., a second total value) is calculated and the ratio of the second total value to the first total value is calculated may be set. Although a total value is used herein as an example of a feature of sensing data to be calculated, another feature such as a maximum value, a minimum value, an average value, or an average value and standard deviation may be used as a feature.

In the case of Example 2, the search result processing part 113 calculates the total value of the most recent sensing data of all the sensor terminals of the sensor type 1 searched and obtained at step S101 (i.e., the first total value), calculates the total value of the most recent sensing data of all the sensor terminals of the sensor type 2 searched and obtained at step S101 (i.e., the second total value), calculates the ratio of the second total value to the first total value, and generates this calculated value as a search result. The most recent sensing data is obtained from the corresponding sensor terminal 130 via the relay server 120 and supplied to the search result processing part 113 by the user command processing part 114.

In a case where an operation such as addition is done by using sensing data of a plurality of sensor terminals as shown in Example 2, it is general that an operation on the user terminal 140 is needed. In other words, the user terminal 140 needs to obtain a list of IDs of sensor terminals agreeing with a search condition by using a single search request, designate the searched and obtained IDs of the sensor terminals to obtain necessary sensing data from the platform device 110, and execute a necessary operation by using an application running on the user terminal 140. On the other hand, in Example 2, a single search request includes a search condition and a process condition, so that it is possible to, by a single search request, cause the platform device 110 to execute an operation using sensing data of a plurality of sensor terminals agreeing with the search condition and obtain the result of the execution.

Thus, according to this exemplary embodiment, the user of the user terminal 140 can easily find the ID and sensing data of a sensor terminal having desired supplementary information. This is because when a search request including a search condition is input from the user terminal 140, the platform device 110 obtains the ID and sensing data of a sensor terminal having supplementary information agreeing with the search condition from the database 111 and transmits to the user terminal 140.

Further, according to this exemplary embodiment, it is possible to hide the content of the sensor terminal basic information 1111 from the user terminal 140. Therefore, the sensor network system 100 according to this exemplary embodiment is suitable for an open sensor network system (a public sensor network system) that the provider of the sensor terminal 130 is different from the user of the user terminal 140.

Further, according to this exemplary embodiment, by a single search request, the user of the user terminal 140 can execute a specific process on the basis of a sensor terminal having desired supplementary information. This is because when a search request including a search condition and a process condition is input from the user terminal 140, the platform device 110 obtains the ID and sensing data of a sensor terminal having supplementary information agreeing with the search request from the database 111, executes a process designated by the process condition on the basis of the obtained ID and sensing data of the sensor terminal, and transmits the result of the execution to the user terminal 140.

Therefore, for example, by designating a process to calculate a feature of sensing data as a process condition, the user of the user terminal 140 can cause the platform device 110 to execute a process to calculate a feature of sensing data of a sensor terminal having desired supplementary information and can obtain the result of the execution by a single search request. Moreover, by setting a condition for an operation of sensing data of sensor terminals as a process condition, the user of the user terminal 140 can cause the platform device 110 to execute an operation using sensing data of sensor terminals having desired supplementary information and can obtain the result of the execution by a single search request. Moreover, for example, by setting a condition for sorting a search result as a process condition, the user of the user terminal 140 can obtain a search result sorted by the set sorting condition.

Various additions and modifications can be made on this exemplary embodiment based on the abovementioned configuration. For example, in a case where execution of a process designated by a process condition is not needed, an exemplary embodiment with a configuration in which the search result processing part 113 is omitted from the configuration shown in FIG. 1 can be conceived as another exemplary embodiment of the present invention.

### Second Exemplary Embodiment

Next, a sensor network system according to a second exemplary embodiment of the present invention will be described.

### <Characteristic of Second Exemplary Embodiment>

This exemplary embodiment provides a method that, in a public sensor network system in which a sensor terminal provider is different from a sensing information user, the sensing information user can find a sensor terminal supplying desired sensing information and make a sensing information request on demand and an individual operation request including update of cache information on a relay server.

### <Task to be Solved by Second Exemplary Embodiment>

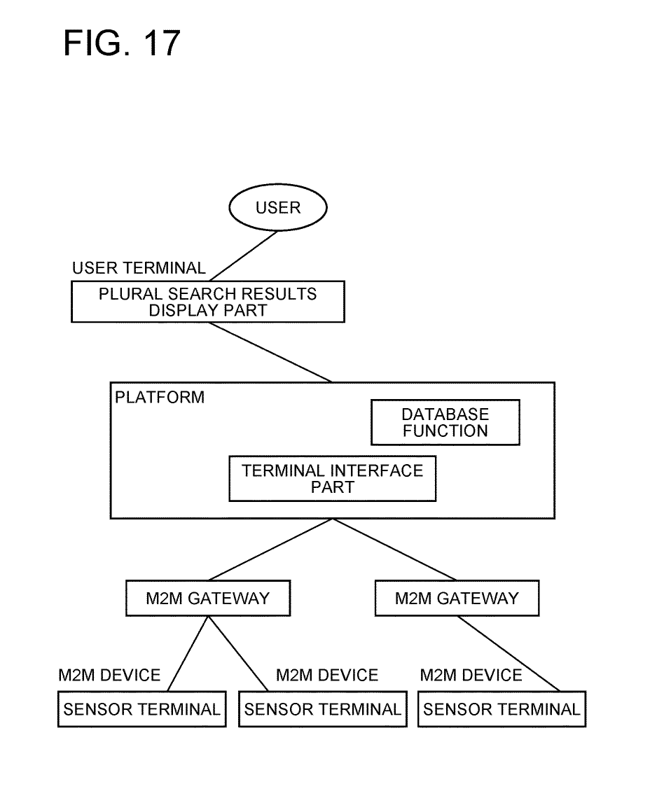

A configuration of a public sensor network system relating to the present invention is shown in FIG. 17. As shown in FIG. 17, in the public sensor network system relating to the present invention, sensing information is saved in a database of a platform and, when the sensing information user searches by designating a desired value (an abnormal value or the like) to the platform, a plurality of sensor terminals having obtained the value can be found. However, in order to select a target from a plurality of search results and make an on-demand sensing information request, an individual operation request including update of cache information on a relay server or the like, a human work is required because it is difficult to previously configure so that an application program of the sensing information user can process the plurality of search results in which, strictly speaking, data structures and data meanings are different from each other.

### <Solution Means According to Second Exemplary Embodiment>

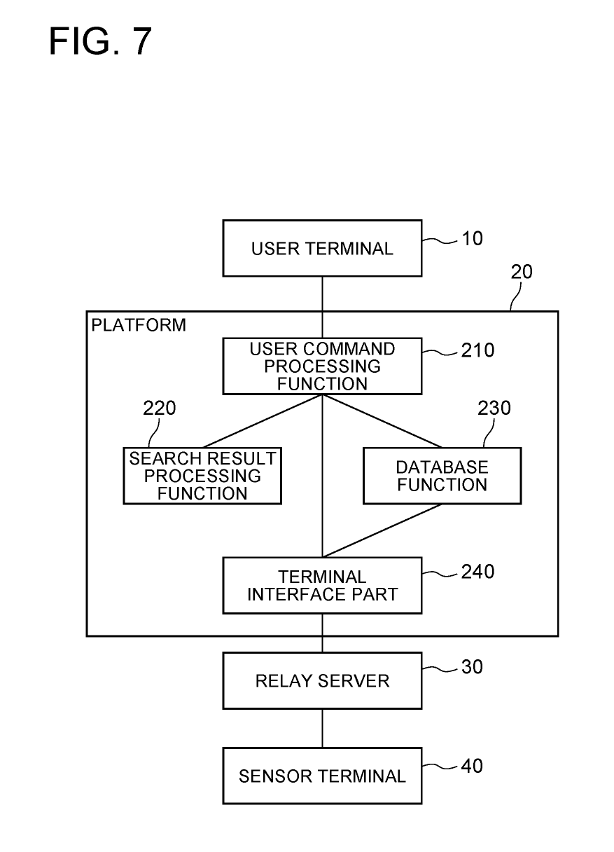

A basic configuration of the public sensor network system according to this exemplary embodiment is shown in FIG. 7. As shown in FIG. 7, in this exemplary embodiment, a platform 20 of the public sensor network system includes, in addition to a database function 230 and a terminal interface part 240, a search result processing function 220 that selects, integrates and statistically processes a plurality of search results, and a user command processing function 210 that makes an on-demand sensing information request or a predetermined individual operation request including update of cache information on a relay server 30 to a sensor terminal extracted as a processing result of the search result processing function 220 and returns the result to a user terminal 10.

By using the platform 20 in this exemplary embodiment, the sensing information user (the user of the user terminal 10) can execute an individual operation on a sensor terminal 40 only by designating a condition such as the location area, sensing time, sensor type, sensing value range or the like of the sensor terminal 40 even the user does not know the ID or address of the sensor terminal 40. For search result processing when a plurality of sensor terminals 40 satisfy the above condition, it is also possible to designate a maximum value, a minimum value, an average value, an average value and standard deviation, a total value, a list and list length, a sorting method or the like at the time of search.

In the public sensor network system, the sensor terminal 40 with a limited scope of disclosure of sensing information or a limited access authority may be connected. In this case, in the search in the platform 20, only information that the sensing information user can access is the target for the search on the basis of authentication of the ID of the sensing information user.

### <Configuration of Second Exemplary Embodiment>

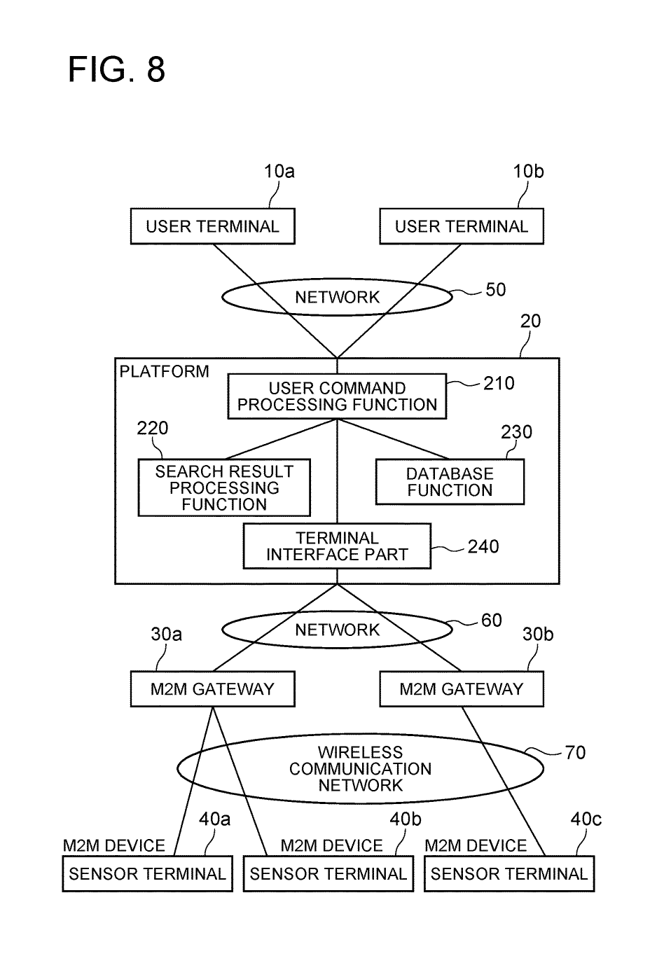

A specific configuration of the public sensor network system according to the second exemplary embodiment is shown in FIG. 8. With reference to FIG. 8, this system includes the platform 20 installed in a cloud, the M2M gateway 30, the M2M device 40 that is a sensor terminal, and the user terminal 10 that transmits a request to the platform 20, receives a processing result and displays it on the screen. The user terminal 10 and the platform 20 are connected by a network 50. The M2M device 40 and the M2M gateway are connected by a wireless communication network 70. The M2M gateway 30 and the platform 20 are connected by a network 60. The networks 50 and 60 may be mobile networks of, for example, 3G or LTE.

For example, the M2M gateway 30 is installed on the roadside, for example, at a part of a bus stop for a regular bus service. The M2M device 40 is owned by a sensor terminal holder, for example, a bus company which operates the regular bus service, and is mounted on the body of a bus connected to the M2M gateway 30 by using a wireless communication means.

The platform 20 has the database function 230 to keep information of the connected M2M gateway 30 and information of the M2M device connected to the M2M gateway 30 and perform search. Moreover, the platform 20 has the search result processing function 220 to process the result of database search, and the user command processing function 210 to receive a command relating to sensing information from the user and use the database function 230 and the search result processing function 220 in accordance with the command and also request an individual operation to a selected sensor terminal. Moreover, the platform 20 has the terminal interface part 240 that is an interface between the platform 20 and the M2M gateway 30. In this exemplary embodiment, the platform 20 includes all the database function 230, the search result processing function 220 and the user command processing function 210. However, according to the present invention, these functions may be separately implemented into different servers (different platforms). Moreover, in a case where the database function 230 is separated from the other functions, a plurality of platforms each including the other functions may be installed in accordance with the number of sensing information users.

### <Operation of Second Exemplary Embodiment>

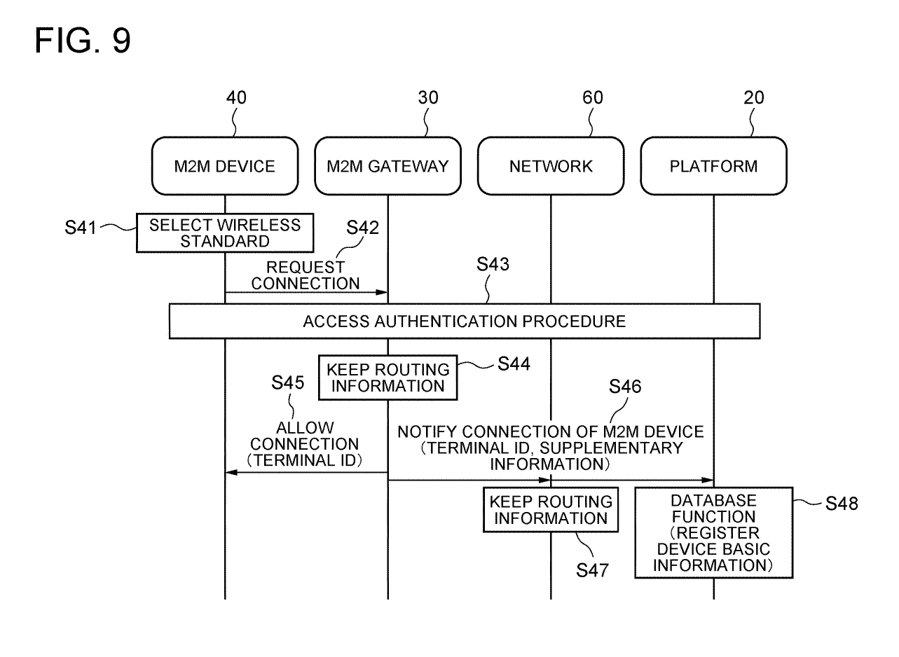

FIG. 9 shows a procedure for connection by the M2M device. Below, an operation of the system when the M2M device is connected will be described with reference to FIG. 9.

The M2M gateway 30 establishes a wireless connection with the M2M device (sensor terminal) 40 through a request operation of a sensor terminal holder based on a predetermined procedure. Regarding a wireless standard used in this case, for example, the M2M device 40 automatically selects an available wireless standard (step S41). Upon receiving a connection request from the M2M device 40 (step S42), the M2M gateway 30 executes predetermined access authentication on the M2M device 40 (step S43). Then, when succeeding in authentication, the M2M gateway 30 keeps routing information of the M2M device 40 (step S44) and gives a terminal ID that uniquely identifies the M2M device 40 (step S45). Further, the M2M gateway 30 notifies the terminal ID together with supplementary information of the M2M device 40 received at the time of connection request of the M2M device, to the platform 20 via the network 60 (step S46). The network 60 then keeps the routing information (step S47).

Supplementary information of the M2M device is information such as the type, specification, attribute, manager's name and installation place of the M2M device. As supplementary information of the M2M device, such information may be directly described, or an URI to content on the network showing such information may be described.

Upon receiving the notification of connection of the M2M device from the M2M gateway 30, the platform 20 writes the content thereof as the device basic information into the database function 230 (step S48).

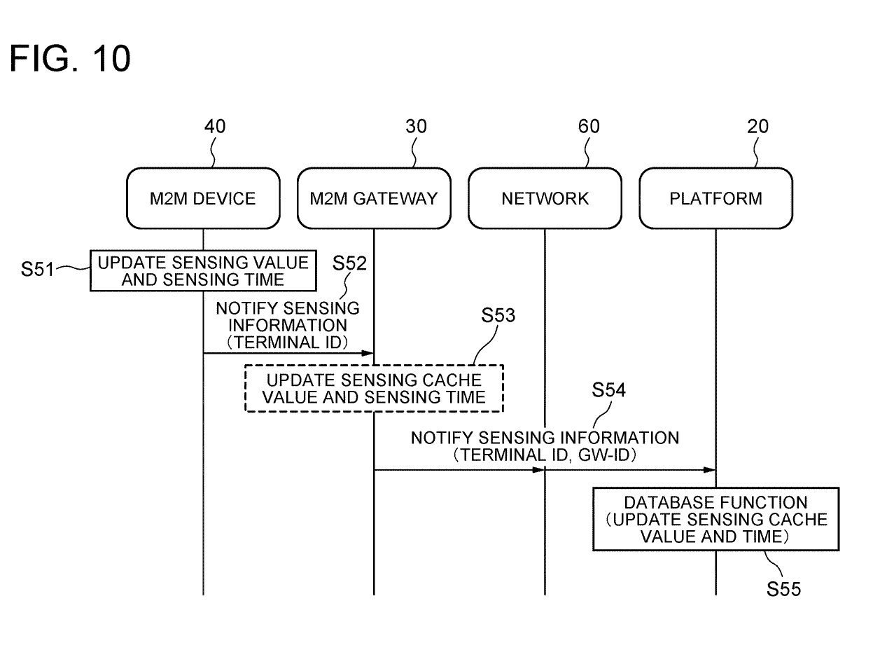

FIG. 10 shows a procedure for notifying sensing information to the platform from the M2M device. Below, the procedure for notifying sensing information will be described with reference to FIG. 10.

When connected to the public sensor network system, the M2M device 40 performs sensing by using a sensor at an appropriate timing (step S51) and notifies sensing information to which the terminal ID of the M2M device 40 is attached to the M2M gateway 30 (step S52). For example, the M2M device 40 notifies the most recent sensing value of the M2M device at a timing of connecting to the M2M gateway 30 or at constant intervals while connecting to the M2M gateway 30. For example, in this exemplary embodiment, the M2M device 40 equipped with a sensor terminal is mounted on the body of a bus, and it connects to the M2M gateway 30 installed at a bus stop by executing wireless communication therewith at a timing of passing the bus stop and notifies bus body information, the destination, passing time and so on as operation information to the M2M gateway 30.

Upon receiving the sensing information notification from the M2M device 40, the M2M gateway 30 saves it into a built-in cache (step S53), and attaches a terminal ID and its gateway ID to the received sensing information notification and transfers it to the platform 20 (step S54). The M2M gateway 30 may then attach information showing an installation place of the M2M gateway, for example. The platform 20 associates the content of the notification with the ID of the M2M gateway having relayed and saves into the database function 230 (step S55).

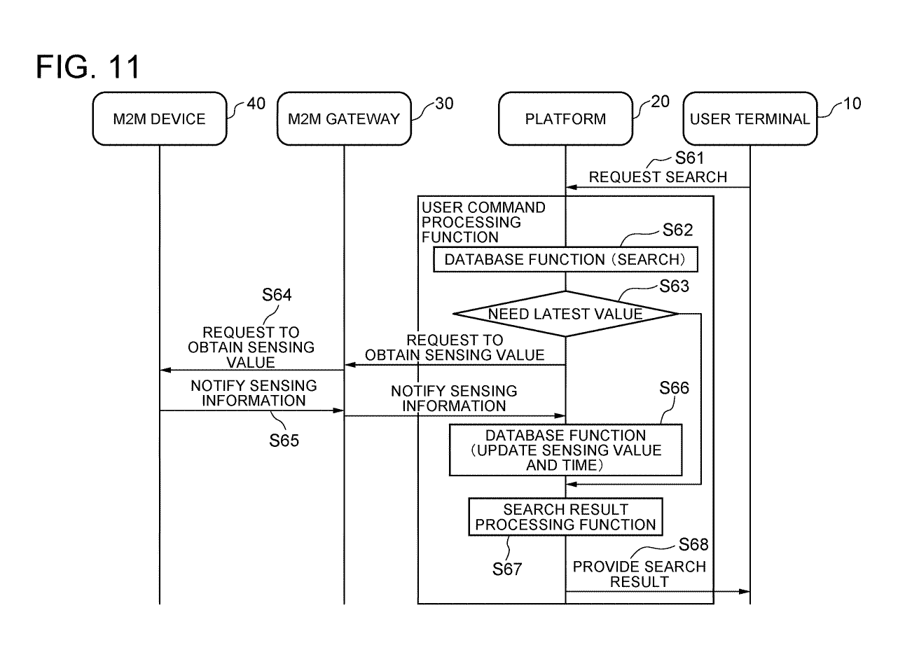

FIG. 11 shows a procedure for the user terminal 10 to obtain sensing information of the M2M device 40. Below, the procedure to obtain sensing information will be described with reference to FIG. 11.

The user terminal 10 requests the platform 20 to search with a designated installation place and sensing time of the M2M device 40, a designated sensor information type and value range, and so on (step S61). For example, near a certain bus stop, the user may make a search request for search of a regular bus sensor by using the user terminal 10. Then, as a search condition, the user may designate the current position and time. The user may designate the current position by using a GPS means accompanying the user terminal 10, for example. Moreover, the user may designate, as a condition, a bus scheduled to arrive at a bus stop in the 30-meter radius from the current position within five minutes from the current time. Furthermore, the user may designate the destination of the regular bus.

Upon receiving the search request, the user command processing function 210 of the platform 20 first searches for device basic information and sensing information satisfying a search condition by using the database function 230 (step S62). In a case where a sensing time is designated in the search condition and newer data than data stored in the database function 230 is needed (step S63), the user command processing function 210 requests the M2M device 40 to obtain a sensing value via the M2M gateway 30 (step S64), receives sensing information notification notified from the M2M device 40 through the M2M gateway 30 (step S65), and stores it into the database function 230 (step S66). After that, the user command processing function 210 causes the search result processing function 220 to execute result processing and finds a target sensor terminal (step S67), and returns the result to the user terminal 10 (step S68).

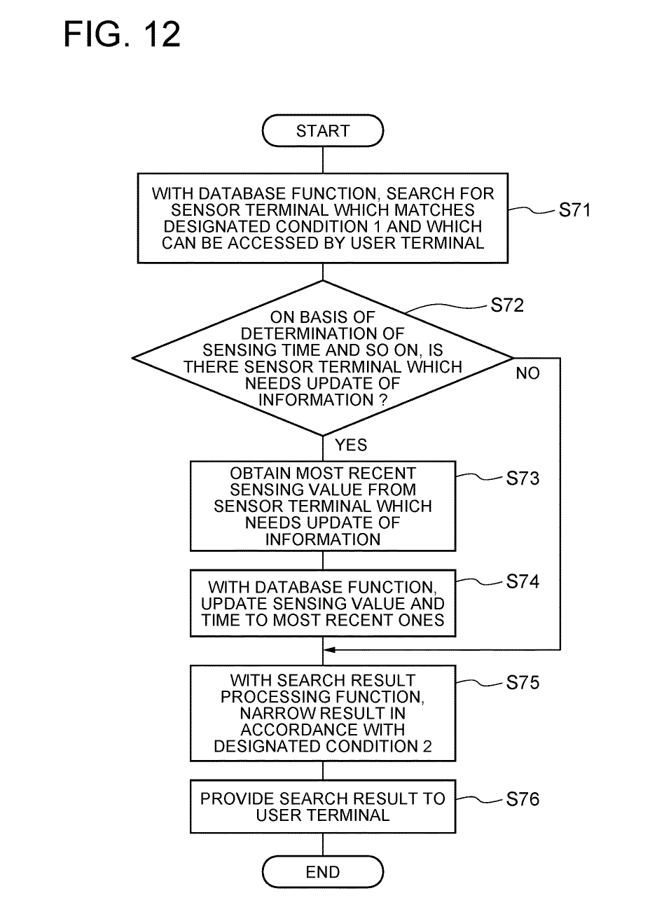

FIG. 12 is a flowchart showing an operation of the user command processing function 210. Below, the operation of the user command processing function 210 will be described with reference to FIG. 12.

Upon receiving a request including a designated condition 1 and a designated condition 2 from the user terminal 10, the user command processing function 210 first causes the database function 230 to search for the M2M device (sensor terminal) 40 which matches the designated condition 1 and which can be accessed by the user terminal 10 (step S41). In the designated condition 1, a sensor installation place, sensing time, a sensor information type, a value range, and so on are designated. In the designated condition 2, the maximum value, the minimum value, the average value, the average value and standard deviation, the total value, a list and list length, a sorting method, and son are designated.

Next, the user command processing function 210 determines sensing time and so on and, in a case where a sensor terminal which needs an update of information is present (step S72), obtains the most recent sensing value from the sensor terminal which needs an update of information (step S73) and causes the database function 230 to update the sensing value and time to the most recent ones (step S74).

Next, the user command processing function 210 causes the search result processing function 220 to narrow the result under the designated condition 2 (step S75). Then, the user command processing function 210 provides the search result to the user terminal 10 (step S76).

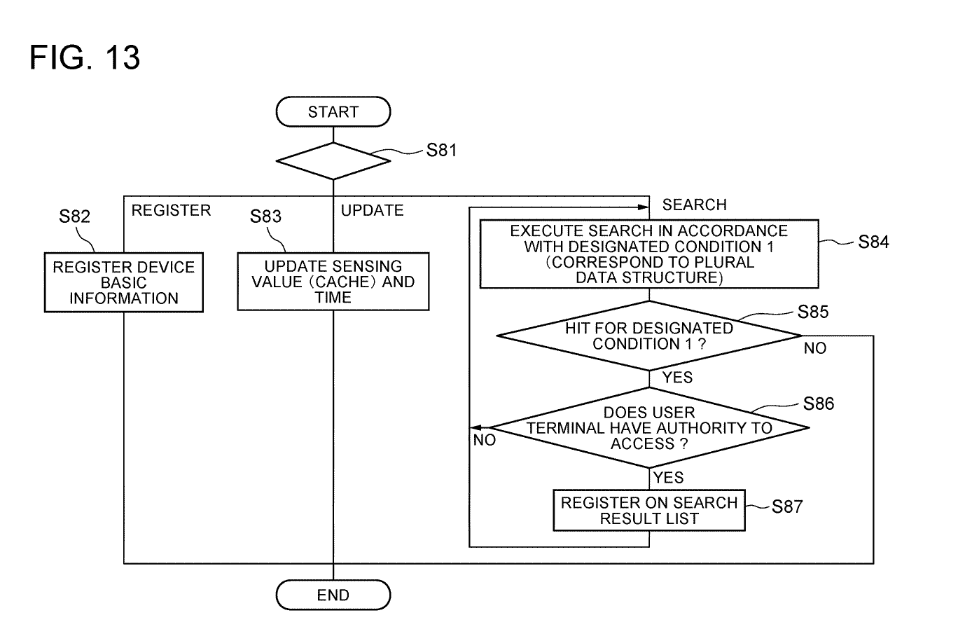

FIG. 13 is a flowchart showing an operation of the database function 230. Below, the operation of the database function 230 will be described with reference to FIG. 13.

The database function 230 divides a process for the types of notification (step S81). In a case where the type of notification is notification of device basic information, the database function 230 stores the notified device basic information into the database (step S82). Device basic information includes a M2M device (sensor terminal) ID, device supplementary information and a M2M gateway ID.

Further, in a case where the type of notification is notification of a sensing value, the database function 230 stores the notified sensing value into the database and updates the sensing time (step S83).

Further, in a case where the type of notification is a search request, the database function 230 executes search under the designated condition 1 included by the search request (step S84). In a case where no device hits for the designated condition 1, the database function 230 ends processing without executing further processes. In a case where a device hits for the designated condition 1, and in a case where the request source user terminal has authority to access the hit M2M device (sensor terminal), the database function 230 registers the hit M2M device (sensor terminal) onto a search result list (step S87), and returns to step S84 to continue processing. After registering onto the list, the database function 230 returns the list as the output result in the end.

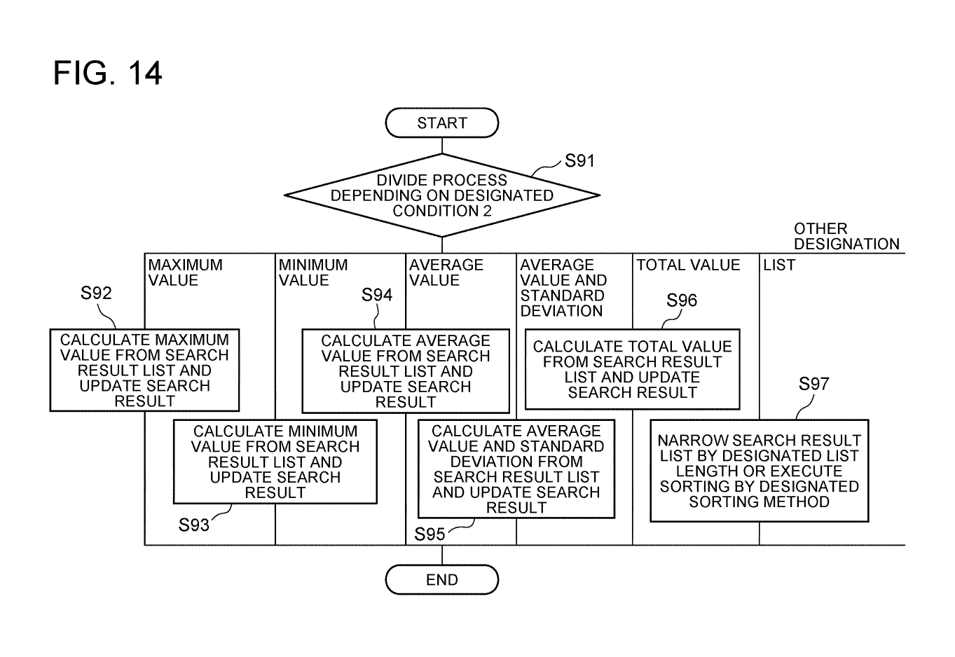

FIG. 14 is a flowchart showing an operation of the search result processing function 220. Below, the operation of the search result processing function 220 will be described with reference to FIG. 14.

The search result processing function 220 divides a process depending on the designated condition 2 (step S91). In a case where the designated condition 2 is “maximum value,” the search result processing function 220 calculates the maximum value from the search result list, and updates the search result (step S92). For example, the search result processing function 220 extracts the ID of the M2M device 40 sensing the maximum sensing value from among the M2M devices written on the search result list, and determines the extracted ID and the maximum sensing value as a search result.

In a case where the designated condition 2 is “minimum value,” the search result processing function 220 calculates the minimum value from the search result list, and updates the search result (step S93). For example, the search result processing function 220 extracts the ID of the M2M device 40 sensing the minimum sensing value from among the M2M devices written on the search result list, and determines the extracted ID and the minimum sensing value as a search result.

In a case where the designated condition 2 is “average value,” the search result processing function 220 calculates the average value from the search result list, and updates the search result (step S94). For example, the search result processing function 220 calculates the average value of sensing values of the M2M devices written on the search result list and determines, as a search result, the calculated average value and a list of the IDs of the M2M devices.

In a case where the designated condition 2 is “average value and standard deviation,” the search result processing function 220 calculates the average value and the standard deviation from the search result list, and updates the search result (step S95). For example, the search result processing function 220 calculates the average value and standard deviation of sensing values of the M2M devices written on the search result list and determines, as a search result, the calculated average value and standard deviation and a list of the IDs of the M2M devices.

In a case where the designated condition 2 is “total value,” the search result processing function 220 calculates the total value from the search result list, and updates the search result (step S96). For example, the search result processing function 220 calculates the total value of sensing values of the M2M devices written on the search result list and determines, as a search result, the calculated total value and a list of the IDs of the M2M devices.

In a case where the designated condition 2 is “list”, the search result processing function 220 narrows the search result list by a designated list length, or executes sorting by a designated sorting method (step S97).

### <Effect of Second Exemplary Embodiment>

According to this exemplary embodiment, in the public sensor network system, the sensing information user can find the M2M device 40 (a sensor terminal) satisfying a desired attribute without creating a special program. Moreover, the sensing information user can obtain the most recent sensing information.

### Third Exemplary Embodiment

Next, a sensor network system according to a third exemplary embodiment of the present invention will be described. In this exemplary embodiment, the present invention is applied to a security system for watching people coming in and out of a shopping mall.

### <Configuration of Third Exemplary Embodiment>

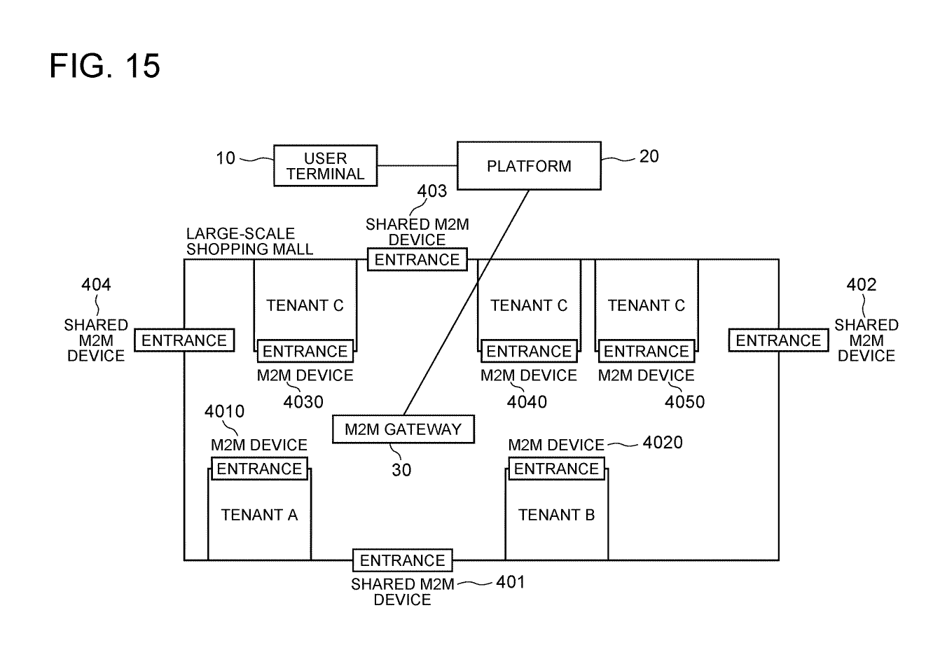

A configuration of the public sensor network system according to the third exemplary embodiment of the present invention is shown in FIG. 15.

The sensor network system according to this exemplary embodiment includes the platform 20 installed in a cloud, the user terminal 10 that transmits a request to the platform 20 via a network means and receives and displays a processing result, the M2M gateway 30 connected to the platform 20 via the network means, and a plurality of M2M devices 4010 to 4050 and 401 to 404.

The M2M gateway 30 is installed at a part of a large-scale shopping area such as a large-scale shopping mall or a shopping avenue.

The plurality of M2M devices are divided into the shared M2M devices 401 to 404 and the dedicated M2M devices 4010 to 4050. The dedicated M2M devices 4010 to 4050 are held by sensor terminals holders, for example, business operators of shops in the large-scale shopping area and installed at the entrances of the respective shops connected to the M2M gateway 30. The dedicated M2M devices 4010 to 4050 each have a security camera function to count the number of people coming in and going out at predetermined time intervals and notify to the M2M gateway 30 by using a wireless communication means. On the other hand, the shared M2M devices 401 to 404 are held by all the business operators of the shops in the large-scale shopping area and installed at all the entrances of the large-scale shopping area connected to the M2M gateway 30. The shared M2M devices 401 to 404 each have a security camera function to count the number of people coming in and going out at predetermined time intervals and notify to the M2M gateway 30 by using a wireless communication means.

### <Operation of Third Exemplary Embodiment>

In this exemplary embodiment, supplementary information of the dedicated M2M device notified by the M2M device when connecting to the M2M gateway includes, in addition to supplementary information of the M2M device shown in the second exemplary embodiment, information showing a shop name and a shop type such as a clothing shop or a grocery store. Moreover, in the case of the shared M2M device, supplementary information thereof includes information showing that the device is shared by the shopping area as a shop type. The dedicated M2M devices and the shared M2M devices each count the number of people coming in and going out by using an accompanying security camera function at predetermined time intervals and notify to the M2M gateway 30.

The M2M gateway 30 transfers the notification from the device with information of the M2M gateway 30 itself attached, to the platform 20.

Upon receiving the notification from the M2M gateway, the platform 20 associates basic information of the M2M device and sensing information such as the number of people coming in and going out for each predetermined time interval with the information of the M2M gateway and keeps them. The basic information of the M2M device includes a terminal ID and the supplementary information of the M2M device.

The user terminal 10 may be a terminal which is held by, for example, the operating company of the large-scale shopping mall and which displays as a graph or the like in real time or outputs as tabular data the number of people coming in and going out of the whole shopping mall for each predetermined time period, and the number of people coming in and going out classified for each shop type or for each shop or the ratio thereof to the whole. Otherwise, the user terminal 10 may be a terminal which is held by each shop operator and which displays as a graph or the like in real time or outputs as tabular data the number of people coming in and going out of the whole shopping mall for each predetermined time period, the total number of people coming in and going out for each shop type, and the number of people coming in and going out of each shop or the ratio thereof to the whole or to the total for the same shop type.

The operating company of the large-scale shopping mall can use the user terminal 10 to evaluate people coming and going out of the whole facility and evaluate the contribution ratio to visitors for each tenant or each shop type. Meanwhile, each shop operator can use the user terminal 10 to evaluate the ratio of visitors of the operator's own shop to those of the whole facility or the same shop type. Moreover, each shop operator may link the user terminal 10 with sales information of a POP system or the like for evaluation and consideration of a countermeasure.

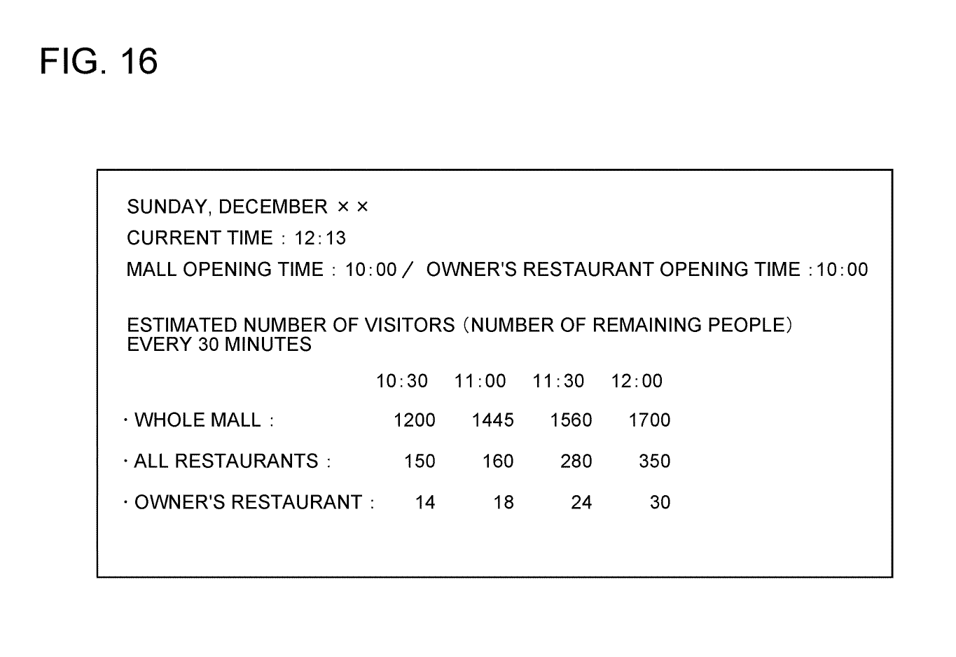

For example, it is assumed that the owner of restaurant A in a large-scale shopping mall checks the content of display on the user terminal 10 held by the restaurant after noon on one holiday and information as shown in FIG. 16 is displayed. The form of such display may be a graph or a table. It is assumed that all the M2M devices installed in this mall notify the numbers of people coming and going out every ten minutes.

The information shown in FIG. 16 is obtained as a result that the owner of the restaurant A requests the platform 20 to search as follows through the user terminal 10.

The user terminal 10 can obtain necessary information by, every ten minutes since ten minutes passes after opening, obtaining (the total number of people coming in—the total number of people going out) of the whole mall for the past ten minutes to leave it as a cumulative value, obtaining (the total number of people coming in—the total number of people going out) of the same type of shops as the owner's shop for the past ten minutes to leave it as a cumulative value and obtaining (the total number of people coming in—the total number of people going out) of the owner's shop for the past ten minutes to leave it as a cumulative value, and the user terminal 10 causes the display part of the user terminal 10 to display numerical values, a graph or a table every 30 minutes on the basis of the information. Further, the user terminal 10 may obtain the average value and standard deviation of all the restaurants, or the rank of the number of visitors of the owner's restaurant among all the restaurants.

### Fourth Exemplary Embodiment

In the first to third exemplary embodiments, when a search request including a search condition and a process condition is input from the user terminal, the user command processing part of the platform device searches the database for sensing data sensed by the sensor terminal including supplementary information agreeing with the search condition, causes the search result processing part to execute a process designated in the process condition on the sensing data of the search result, and outputs the execution result as a search result to the user terminal. On the other hand, when a search request including a search condition and a process condition is input from the user terminal, the user command processing part of the platform device in this exemplary embodiment searches the database for identification information of the sensor terminal including supplementary information agreeing with the search condition, causes the search result processing part to execute a process designated in the process condition on the identification information of the search result, and outputs the execution result as a search result to the user terminal.

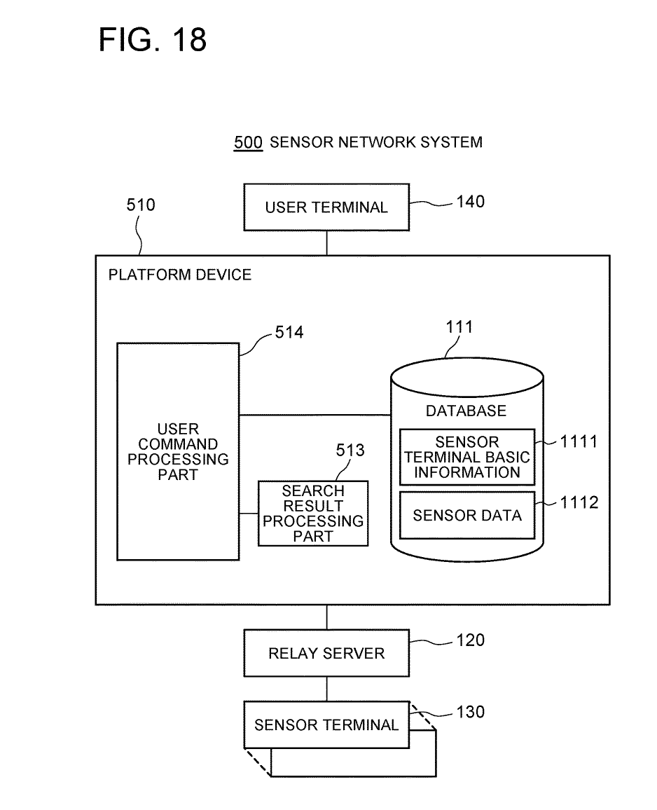

With reference to FIG. 18, a sensor network system 500 according to a fourth exemplary embodiment of the present invention includes a platform device 510, the relay server 120, the plurality of sensor terminals 130 connected to the platform device 510 via the relay server 120, and the user terminal 140 connected to the platform device 510. FIG. 18 shows one user terminal 140 and one relay server 120, but there may be a plurality of user terminals 140 and relay servers 120.

The relay server 120, the sensor terminal 130 and the user terminal 140 described above have the same functions as the relay server 120, the sensor terminal 130 and the user terminal 140 shown in FIG. 1.

The platform device 510 has the database 111, a search result processing part 513, and a user command processing part 514.

The database 111 has the same function as the database 111 shown in FIG. 1. That is, as an example, in the database 111, supplementary information of a sensor terminal, sensing data, and a sensor terminal ID are associated by using two kinds of data including the sensor terminal basic information 1111 and the sensor data 1112. However, supplementary information of a sensor terminal, sensing data, and a sensor terminal ID may be associated and stored by using one kind of data or three or more kinds of data.

The sensor terminal basic information 1111 is the same as the sensor terminal basic information 1111 shown in FIG. 1 and, as shown in FIG. 2, includes a sensor terminal ID and a plurality of supplementary information.

The sensor data 1112 is the same as the sensor data 1112 shown in FIG. 1 and, as shown in FIG. 3, includes a sensor terminal ID, an acquisition time and date, and sensing data.

The user command processing part 514 has a function to receive a search request including a search condition and a process condition input from the user terminal 140. The search condition designates one or more supplementary information. Moreover, the process condition designates a process that should be executed on the basis of a sensor terminal ID of a search result.

Further, the user command processing part 514 has a function to search the database 111 for the ID of a sensor terminal having supplementary information agreeing with the search condition included by the search request. To be specific, the user command processing part 114 searches the database 111 for the sensor terminal basic information 1111 including supplementary information agreeing with supplementary information designated as the search condition, and obtains a sensor terminal ID included by the searched and obtained sensor terminal basic information 1111.

Further, the user command processing part 514 has a function to notify a search result and a process condition included by a search request to the search result processing part 513 and output an execution result received from the search result processing part 513 as a search result to the user terminal 140. Moreover, in a case where the most recent sensing data is needed for execution of a process corresponding to a process condition, the user command processing part 514 obtains the most recent sensing data from the sensor terminal 130 via the relay server 120 and notifies a search result including the most recent sensing data to the search result processing part 513.

The search result processing part 513 has a function to, when a search result and a process condition are notified by the user command processing part 514, execute a process designated by the process condition on the basis of a sensor terminal ID of the search result and return the execution result to the user command processing part 514.

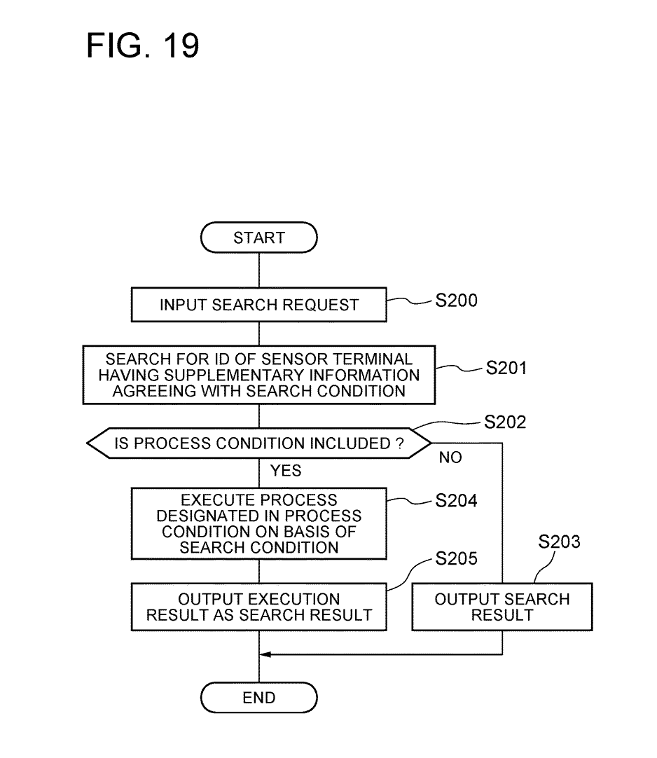

FIG. 19 is a flowchart showing an example of an operation of the platform device 510. Below, the operation in this exemplary embodiment will be described with reference to FIG. 19.

When the user of the user terminal 140 wants to obtain the ID of the sensor terminal 130 having desired supplementary information, the user transmits a search request with the desired supplementary information set as a search condition to the platform device 510 from the user terminal 140. FIG. 5 shows an example of such a search result. The search request of this example includes the ID of the user terminal 140 and the search condition.

Further, in a case where the user of the user terminal 140 wants to execute a specific process on the basis of the ID of the sensor terminal 130 having desired supplementary information, the user sets the desired supplementary information as a search condition, and transmits a search request with the specific process set as a process condition to the platform device 510 from the user terminal 140. FIG. 6 shows an example of such a search request. The search request of this example includes the ID of the user terminal 140, the search condition, and the process condition. The search condition may be referred to as a first designated condition, and the process condition may be referred to as a second designated condition.

Upon receiving a search request from the user terminal 140 (step S200), the user command processing part 514 of the platform device 510 searches the database 111 for the ID of the sensor terminal 130 having supplementary information agreeing with a search condition included by the search request (step S201).

Next, the user command processing part 514 determines whether the search request includes a process condition (step S202). In a case where the search request does not include a process condition, that is, the search request is as shown in FIG. 5, the user command processing part 514 transmits a search result in which the ID of the sensor terminal searched and obtained at step S201 is written to the user terminal 140 (step S203). The platform device 510 may create, in the database 111, a URI indicating the sensing data 1112 showing the sensor terminal ID obtained as the search result and transmit it to the user terminal 140 as a search result (not shown in the drawings). Upon receiving the search result from the platform device 510, the user terminal 140 displays the search result on the screen of the user terminal 140.

Further, in a case where the search request includes a process condition, that is, the search request is as shown in FIG. 6, the user command processing part 514 uses the search request processing part 513 to execute a process designated in the process condition included by the search request on the basis of the ID of the sensor terminal searched and obtained at step S201 (step S204). In a case where the most recent sensing data of the sensor terminal is needed for execution of the process corresponding to the process condition, the user command processing part 514 obtains the most recent sensing data from the sensor terminal 130 via the relay server 120 and provides it to the search result processing part 513.

Next, the user command processing part 514 transmits the result of the execution by the search result processing part 513 as a search result to the user terminal 140 (step S205). Upon receiving the search result from the platform device 510, the user terminal 140 displays the search result on the screen of the user terminal 140.

Next, an example of a process condition will be described.

### Example 1

As a process condition, it may be set that a process condition that a search result is sorted by a specific sorting method. In this case, the search result processing part 513 generates, as a search result, a result of sorting sensor terminal IDs searched and obtained at step S201 or the URIs including the sensor terminal IDs by the specific method. In a case where the search result includes a plurality of results, it is general that the results are sorted by a sorting method determined by the system and output to the user terminal 140. However, according to this exemplary embodiment, a sorting method can be set as a process condition, so that the user can obtain a search result in which results are sorted by a sorting method which is appropriate for the user.

### Example 2

As a process condition, it may be set that a period, a type of a feature, and a reference value are designated and the ID of a sensor terminal in which the designated type of feature among features of sensing data sensed during the designated period agrees with the designated reference value is calculated. As a type of a feature, for example, a maximum value, a minimum value, an average value, an average value and standard deviation, a total value, and so on are considered. As a period, a period what time it starts and ends may be designated, or a starting point such as on and after what time and an ending point such as on and before what time may be designated. As a reference value, an upper limit value, a lower limit value, or both of them may be designated.

In the example 2, the search result processing part 513, among the sensor terminal IDs included by the sensor terminal basic information 1111 searched and obtained at step S201, calculates the ID of a sensor terminal in which the designated type of feature among features of sensing data during the designated period agrees with the designated reference value, and generates a search result showing the calculated sensor terminal ID or the URI indicating the sensing data 1112 including the sensor terminal ID. The user command processing part 514 searches the database 111 to obtain a feature of sensing data during a designated period from the sensor data 1112, and supplies to the search result processing part 513. In a case where the most recent sensing data is needed, the user command processing part 514 obtains the most recent sensing data from the sensor terminal 130 via the relay server 120, and supplies it to the search result processing part 513.

In order to further narrow a search result including a plurality of sensor terminal IDs as described in the example 2, another procedure on the user terminal 140 is needed in general. That is to say, the user terminal 140 needs a procedure such as obtaining a list of sensor terminals IDs agreeing with a search condition on the basis of a single search request, subsequently obtaining sensing data for a necessary period from the platform device 510 with the searched and obtained sensor terminal IDs designated, and obtaining a sensor terminal ID agreeing with a process condition by using an application running on the user terminal 140. On the other hand, in the example 2, a single search request includes a search condition and a process condition, so that it is possible to further narrow a plurality of sensor terminal IDs or URIs indicating sensing data agreeing with the search condition on the basis of a single search request.

Thus, according to this exemplary embodiment, the user of the user terminal 140 can easily find a sensor terminal having desired supplementary information. This is because when a search request including a search condition is input from the user terminal 140, the platform device 510 searches the database for the ID of a sensor terminal having supplementary information agreeing with the search condition and transmits to the user terminal 140.

Further, according to this exemplary embodiment, it is possible to hide the content of the sensor terminal basic information 1111 from the user terminal 140. Therefore, the sensor network system 500 according to this exemplary embodiment is suitable for an open sensor network system (a public sensor network system) in which the provider of the sensor terminal 130 is different from the user of the user terminal 140.

Further, according to this exemplary embodiment, the user of the user terminal 140 can execute a specific process on the basis of a sensor terminal having desired supplementary information upon a single search request. This is because when a search request including a search condition and a process condition is input from the user terminal 140, the platform device 510 searches the database 111 for the ID of a sensor terminal having supplementary information agreeing with the search condition and, on the basis of the searched and obtained ID of the sensor terminal, executes a process designated by the process condition, and transmits the execution result to the user terminal 140.

Further, according to this exemplary embodiment, by setting a condition for narrowing a search result (e.g., a feature of sensing data) as a process condition, the user of the user terminal 140 can perform search with desired supplementary information and narrow a search result under a specific condition upon a single search request. This is because the platform device 510 extracts the IDs of sensor terminals agreeing with a process condition from a search result to narrow the search result.

Further, according to this exemplary embodiment, by setting a condition for sorting a search result as a process condition, the user of the user terminal 140 can obtain a search result sorted under the set sorting condition.

This exemplary embodiment can be subjected to various additions and modifications on the basis of the configuration described above. For example, in a case where execution of a process under a process condition is not needed, an exemplary embodiment with a configuration that the search result processing part 513 is omitted from the configuration shown in FIG. 18 can be conceived as another exemplary embodiment of the present invention.

### Fifth Exemplary Embodiment

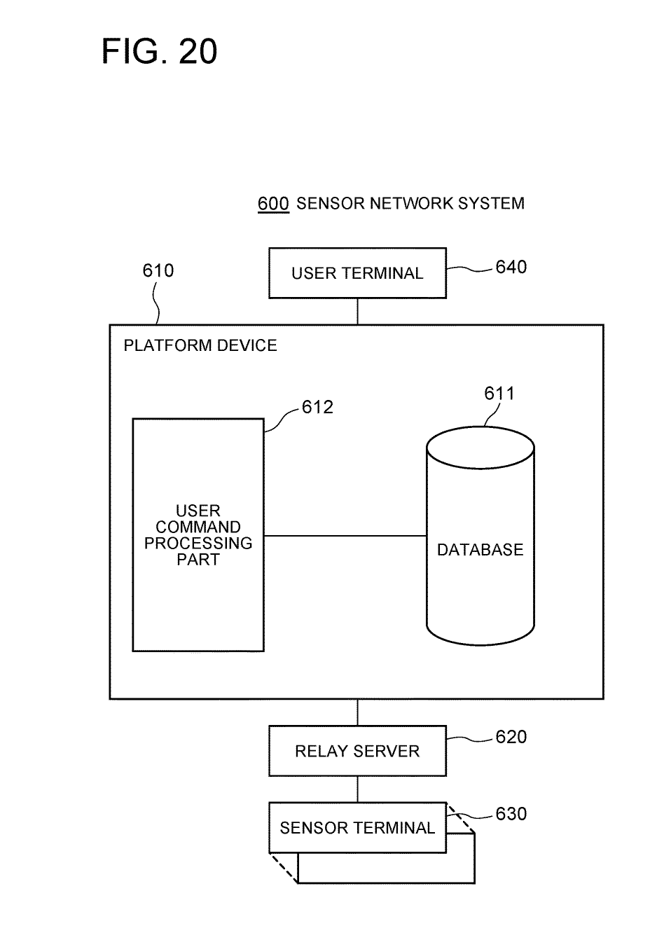

With reference to FIG. 20, a sensor network system 600 according to a fifth exemplary embodiment of the present invention includes a platform device 610, a relay server 620, a plurality of sensor terminals 630 connected to the platform device 610 via the relay server 620, and a user terminal 640 connected to the platform device 610. FIG. 20 shows one user terminal 640 and one relay server 620, but there may be a plurality of user terminals 640 and relay servers 620.

The platform device 610 includes a database 611 and a user command processing part 612.

The database 611 has a function to associate and keep supplementary information of a sensor terminal, sensing data and a sensor terminal ID. In the drawings, the database 611 is placed in the platform device 610. However, the database 611 may be placed outside the platform device 610.

The user command processing part 612 has a function to receive a search request including a search condition from the user terminal 640. A search condition designates one or more supplementary information.

Further, the user command processing part 612 has a function to search the database 611 upon the search request and output a search result to the user terminal 640.

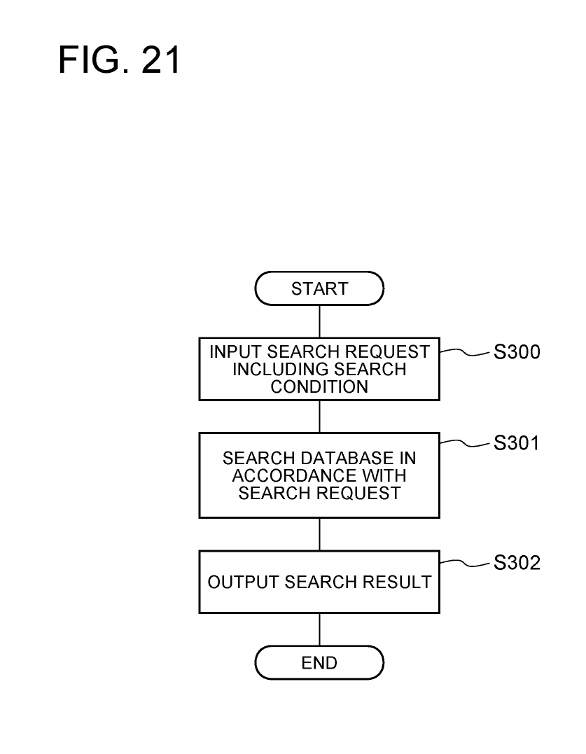

FIG. 21 is a flowchart showing an example of an operation of the platform device 610. Below, the operation in this exemplary embodiment will be described with reference to FIG. 21.

Upon receiving a search request from the user terminal 640 (step S300), the user command processing part 612 of the platform device 610 searches the database 611 in accordance with the search request (step S301). Because supplementary information of a sensor terminal, sensing data and a sensor terminal ID are associated and stored in the database 611, it is possible, by searching with supplementary information of a sensor terminal as a search condition, to obtain either the ID of a sensor terminal having supplementary information designated by the search condition or sensing data of the sensor terminal having the supplementary information designated by the search condition or both of them from the database 611.

Next, the user command processing part 612 transmits the result of the search by the database 611 to the user terminal 640 (step S302).

Upon receiving the search result from the platform device 610, the user terminal 640 displays the search result on the screen of the user terminal 640.

Thus, according to this exemplary embodiment, it is possible to search even when identification information of a sensor terminal from which the user wants to obtain sensing data is unknown, and it is also possible to easily find a sensor terminal having desired supplementary information. This is because when a search request with supplementary information of a sensor terminal set as a search condition is input from the user terminal 640, the platform device 610 searches the database 611 in which supplementary information of a sensor terminal, sensing data sensed by the sensor terminal and identification information of the sensor terminal are associated and stored, in accordance with the search request, and outputs a search result to the user terminal 640.

Although the present invention has been described above with reference to the exemplary embodiments, the present invention is not limited to the exemplary embodiments. The configurations and details of the present invention can be changed in various manners that can be understood by one skilled in the art within the scope of the present invention.

The present invention is based upon and claims the benefit of priority from Japanese patent application No. 2015-066400, filed on Mar. 27, 2015, the disclosure of which is incorporated herein in its entirety by reference.

### INDUSTRIAL APPLICABILITY

The present invention can be used for general sensor network systems and is particularly favorable for an open sensor network system in which the provider of a sensor terminal and the user of sensing data are different.

The whole or part of the exemplary embodiments disclosed above can be described as the following supplementary notes, but are not limited to the following configurations.

### [Supplementary Note 1]

A sensor network system comprising:

a platform device;

a plurality of sensor terminals connected to the platform device via a relay server; and

a user terminal connected to the platform device,

wherein the platform device includes a user command processing part configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

### [Supplementary Note 2]

The sensor network system according to Supplementary Note 1, wherein the user command processing part is configured to search the database for the sensing data sensed by the sensor terminal having the supplementary information agreeing with the search condition.

### [Supplementary Note 3]

The sensor network system according to Supplementary Note 2, wherein:

the platform device further includes a search result processing part configured to execute a process on a basis of the search result; and

the user command processing part is configured to, upon receiving a search request including the search condition and a process condition from the user terminal, execute a process designated by the process condition on the sensing data of the search result by use of the search result processing part, and output an execution result as the search result to the user terminal.

### [Supplementary Note 4]

The sensor network system according to Supplementary Note 3, wherein the process designated by the process condition is a process of calculating a feature of the sensing data.

### [Supplementary Note 5]

The sensor network system according to Supplementary Note 3, wherein the process designated by the process condition is a process of sorting the sensing data by a designated method.

### [Supplementary Note 6]

The sensor network system according to any of Supplementary Notes 3 to 5, wherein the user command processing part is configured to, when most recent sensing data is needed to execute the process designated by the process condition, obtain the most recent sensing data from the sensor terminal through the relay server.

### [Supplementary Note 7]

The sensor network system according to Supplementary Note 1, wherein the user command processing part is configured to search the database for the identification information of the sensor terminal having the supplementary information agreeing with the search condition.

### [Supplementary Note 8]

The sensor network system according to Supplementary Note 7, wherein:

the platform device further includes a search result processing part configured to execute a process on a basis of the search result; and

the user command processing part is configured to, upon receiving a search request including the search condition and a process condition from the user terminal, execute a process designated by the process condition on the identification information of the search result by use of the search result processing part, and output an execution result as the search result to the user terminal.

### [Supplementary Note 9]

The sensor network system according to Supplementary Note 8, wherein the process designated by the process condition is a process of extracting, from the search result, the identification information of the sensor terminal that a feature of the sensing data agrees with a designated value.

### [Supplementary Note 10]

The sensor network system according to Supplementary Note 8, wherein the process designated by the process condition is a process of sorting the identification information of the sensor terminals by a designated method.

### [Supplementary Note 11]

The sensor network system according to any of Supplementary Notes 8 to 10, wherein the user command processing part is configured to, when most recent sensing data is needed to execute the process designated by the process condition, obtain the most recent sensing data from the sensor terminal through the relay server.

### [Supplementary Note 12]

A platform device connected to a relay server and a user terminal, a plurality of sensor terminals being connected to the relay server,

the platform device comprising a user command processing part configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

### [Supplementary Note 13]

The platform device according to Supplementary Note 12, wherein the user command processing part is configured to search the database for the sensing data sensed by the sensor terminal having the supplementary information agreeing with the search condition.

### [Supplementary Note 14]

The platform device according to Supplementary Note 13, further comprising a search result processing part configured to execute a process on a basis of the search result,

wherein the user command processing part is configured to, upon receiving a search request including the search condition and a process condition from the user terminal, execute a process designated by the process condition on the sensing data of the search result by use of the search result processing part, and output an execution result as the search result to the user terminal.

### [Supplementary Note 15]

The platform device according to Supplementary Note 14, wherein the process designated by the process condition is a process of calculating a feature of the sensing data.

### [Supplementary Note 16]

The platform device according to Supplementary Note 14, wherein the process designated by the process condition is a process of sorting the sensing data by a designated method.

### [Supplementary Note 17]

The platform device according to any of Supplementary Notes 14 to 16, wherein the user command processing part is configured to, when most recent sensing data is needed to execute the process designated by the process condition, obtain the most recent sensing data from the sensor terminal through the relay server.

### [Supplementary Note 18]

The platform device according to Supplementary Note 12, wherein the user command processing part is configured to search the database for the identification information of the sensor terminal having the supplementary information agreeing with the search condition.

### [Supplementary Note 19]

The platform device according to Supplementary Note 18, further comprising a search result processing part configured to execute a process on a basis of the search result,

wherein the user command processing part is configured to, upon receiving a search request including the search condition and a process condition from the user terminal, execute a process designated by the process condition on the identification information of the search result by use of the search result processing part, and output an execution result as the search result to the user terminal.

### [Supplementary Note 20]

The platform device according to Supplementary Note 19, wherein the process designated by the process condition is a process of extracting, from the search result, the identification information of the sensor terminal that a feature of the sensing data agrees with a designated value.

### [Supplementary Note 21]

The platform device according to Supplementary Note 19, wherein the process designated by the process condition is a process of sorting the identification information of the sensor terminals by a designated method.

### [Supplementary Note 22]

The platform device according to any of Supplementary Notes 19 to 21, wherein the user command processing part is configured to, when most recent sensing data is needed to execute the process designated by the process condition, obtain the most recent sensing data from the sensor terminal through the relay server.

### [Supplementary Note 23]

A method executed by a platform device connected to a relay server and a user terminal, a plurality of sensor terminals being connected to the relay server, the method comprising:

receiving, from the user terminal, a search request including supplementary information of the sensor terminal as a search condition;

searching, in accordance with the search request, a database in which supplementary information of the sensor terminals, sensing data sensed by the sensor terminals, and identification information of the sensor terminals are associated and stored; and

outputting a search result to the user terminal.

### [Supplementary Note 24]

The method according to Supplementary Note 23, wherein, in the searching, the database is searched for the sensing data sensed by the sensor terminal having the supplementary information agreeing with the search condition.

### [Supplementary Note 25]

The method according to Supplementary Note 24, comprising:

receiving a search request including the search condition and a process condition from the user terminal; and

executing a process designated by the process condition on the sensing data of the search result, and outputting an execution result as the search result to the user terminal.

### [Supplementary Note 26]

The method according to Supplementary Note 25, wherein the process designated by the process condition is a process of calculating a feature of the sensing data.

### [Supplementary Note 27]

The method according to Supplementary Note 25, wherein the process designated by the process condition is a process of sorting the sensing data by a designated method.

### [Supplementary Note 28]

The method according to any of Supplementary Notes 25 to 27, comprising, when most recent sensing data is needed to execute the process designated by the process condition, obtaining the most recent sensing data from the sensor terminal through the relay server.

### [Supplementary Note 29]

The method according to Supplementary Note 23, wherein, in the searching, the database is searched for the identification information of the sensor terminal having the supplementary information agreeing with the search condition.

### [Supplementary Note 30]

The method according to Supplementary Note 29, comprising:

receiving a search request including the search condition and a process condition from the user terminal; and

executing a process designated by the process condition on the identification information of the search result, and outputting an execution result as the search result to the user terminal.

### [Supplementary Note 31]

The method according to Supplementary Note 30, wherein the process designated by the process condition is a process of extracting, from the search result, the identification information of the sensor terminal that a feature of the sensing data agrees with a designated value.

### [Supplementary Note 32]

The method according to Supplementary Note 30, wherein the process designated by the process condition is a process of sorting the identification information of the sensor terminals by a designated method.

### [Supplementary Note 33]

The method according to any of Supplementary Notes 30 to 32, comprising, when most recent sensing data is needed to execute the process designated by the process condition, obtaining the most recent sensing data from the sensor terminal through the relay server.

### [Supplementary Note 34]

A computer program comprising instructions for causing a computer to function as a user command processing part, the computer being connected to a relay server and a user terminal, a plurality of sensor terminals being connected to the relay server,

the user command processing part being configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

### [Supplementary Note 35]

The computer program according to Supplementary Note 34, wherein the user command processing part is configured to search the database for the sensing data sensed by the sensor terminal having the supplementary information agreeing with the search condition.

### [Supplementary Note 36]

The computer program according to Supplementary Note 35, further comprising instructions for causing the computer to function as a search result processing part configured to execute a process on a basis of the search result,

wherein the user command processing part is configured to, upon receiving a search request including the search condition and a process condition from the user terminal, execute a process designated by the process condition on the sensing data of the search result by use of the search result processing part, and output an execution result as the search result to the user terminal.

### [Supplementary Note 37]

The computer program according to Supplementary Note 36, wherein the process designated by the process condition is a process of calculating a feature of the sensing data.

### [Supplementary Note 38]

The computer program according to Supplementary Note 36, wherein the process designated by the process condition is a process of sorting the sensing data by a designated method.

### [Supplementary Note 39]

The computer program according to any of Supplementary Notes 36 to 38, wherein the user command processing part is configured to, when most recent sensing data is needed to execute the process designated by the process condition, obtain the most recent sensing data from the sensor terminal through the relay server.

### [Supplementary Note 40]

The computer program according to Supplementary Note 34, wherein the user command processing part is configured to search the database for the identification information of the sensor terminal having the supplementary information agreeing with the search condition.

### [Supplementary Note 41]

The computer program according to Supplementary Note 40, further comprising instructions for causing the computer to function as a search result processing part configured to execute a process on a basis of the search result,

wherein the user command processing part is configured to, upon receiving a search request including the search condition and a process condition from the user terminal, execute a process designated by the process condition on the identification information of the search result by use of the search result processing part, and output an execution result as the search result to the user terminal.

### [Supplementary Note 42]

The computer program according to Supplementary Note 41, wherein the process designated by the process condition is a process of extracting, from the search result, the identification information of the sensor terminal that a feature of the sensing data agrees with a designated value.

### [Supplementary Note 43]

The computer program according to Supplementary Note 41, wherein the process designated by the process condition is a process of sorting the identification information of the sensor terminals by a designated method.

### [Supplementary Note 44]

The computer program according to any of Supplementary Notes 41 to 43, wherein the user command processing part is configured to, when most recent sensing data is needed to execute the process designated by the process condition, obtain the most recent sensing data from the sensor terminal through the relay server.

### DESCRIPTION OF NUMERALS

10 user terminal
20 platform
30 M2M gateway (relay server)
40 M2M device (sensor terminal)
50 network
60 network
70 wireless communication network
100 sensor network system
110 platform device
111 database
113 search result processing part
114 user command processing part
120 relay server
130 sensor terminal
140 user terminal
210 user command processing function
220 search result processing function
230 database function
240 terminal interface part
401-404 shared M2M device
1111 sensor terminal basic information
1112 sensor data
4010-4050 dedicated M2M device
500 sensor network system
510 platform device
513 search result processing part
514 user command processing part
600 sensor network system
610 platform device
611 database
612 user command processing part
620 relay server
630 sensor terminal
640 user terminal

1. A sensor network system comprising:
a platform device;
a plurality of sensor terminals connected to the platform device via a relay server; and
a user terminal connected to the platform device,
wherein the platform device includes a user command processing part configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

2. The sensor network system according to claim 1, wherein the user command processing part is configured to search the database for the sensing data sensed by the sensor terminal having the supplementary information agreeing with the search condition.

3. The sensor network system according to claim 2, wherein:
the platform device further includes a search result processing part configured to execute a process on a basis of the search result; and
the user command processing part is configured to, upon receiving a search request including the search condition and a process condition from the user terminal, execute a process designated by the process condition on the sensing data of the search result by use of the search result processing part, and output an execution result as the search result to the user terminal.

4. The sensor network system according to claim 1, wherein the user command processing part is configured to search the database for the identification information of the sensor terminal having the supplementary information agreeing with the search condition.

5. The sensor network system according to claim 4, wherein:
the platform device further includes a search result processing part configured to execute a process on a basis of the search result; and
the user command processing part is configured to, upon receiving a search request including the search condition and a process condition from the user terminal, execute a process designated by the process condition on the identification information of the search result by use of the search result processing part, and output an execution result as the search result to the user terminal.

6. A platform device connected to a relay server and a user terminal, a plurality of sensor terminals being connected to the relay server,
the platform device comprising a user command processing part configured to: receive, from the user terminal, a search request including supplementary information of the sensor terminal as a search condition; in accordance with the search request, search a database in which supplementary information of the sensor terminals, sensing data sensed by the sensor terminals, and identification information of the sensor terminals are associated and stored; and output a search result to the user terminal.

7. The platform device according to claim 6, wherein the user command processing part is configured to search the database for the sensing data sensed by the sensor terminal having the supplementary information agreeing with the search condition.

8. The platform device according to claim 7, further comprising a search result processing part configured to execute a process on a basis of the search result,
wherein the user command processing part is configured to, upon receiving a search request including the search condition and a process condition from the user terminal, execute a process designated by the process condition on the sensing data of the search result by use of the search result processing part, and output an execution result as the search result to the user terminal.

9. The platform device according to claim 8, wherein the process designated by the process condition is a process of calculating a feature of the sensing data.

10. The platform device according to claim 8, wherein the process designated by the process condition is a process of sorting the sensing data by a designated method.

11. The platform device according to claim 8, wherein the user command processing part is configured to, when most recent sensing data is needed to execute the process designated by the process condition, obtain the most recent sensing data from the sensor terminal through the relay server.

12. The platform device according to claim 6, wherein the user command processing part is configured to search the database for the identification information of the sensor terminal having the supplementary information agreeing with the search condition.

13. The platform device according to claim 12, further comprising a search result processing part configured to execute a process on a basis of the search result,
wherein the user command processing part is configured to, upon receiving a search request including the search condition and a process condition from the user terminal, execute a process designated by the process condition on the identification information of the search result by use of the search result processing part, and output an execution result as the search result to the user terminal.

14. The platform device according to claim 13, wherein the process designated by the process condition is a process of extracting, from the search result, the identification information of the sensor terminal that a feature of the sensing data agrees with a designated value.

15. The platform device according to claim 13, wherein the process designated by the process condition is a process of sorting the identification information of the sensor terminals by a designated method.

16. The platform device according to claim 13, wherein the user command processing part is configured to, when most recent sensing data is needed to execute the process designated by the process condition, obtain the most recent sensing data from the sensor terminal through the relay server.

17. A method executed by a platform device connected to a relay server and a user terminal, a plurality of sensor terminals being connected to the relay server, the method comprising:
receiving, from the user terminal, a search request including supplementary information of the sensor terminal as a search condition;
searching, in accordance with the search request, a database in which supplementary information of the sensor terminals, sensing data sensed by the sensor terminals, and identification information of the sensor terminals are associated and stored; and
outputting a search result to the user terminal.

18. The method according to claim 17, wherein, in the searching, the database is searched for the sensing data sensed by the sensor terminal having the supplementary information agreeing with the search condition.

19. The method according to claim 18, comprising:
receiving a search request including the search condition and a process condition from the user terminal; and
executing a process designated by the process condition on the sensing data of the search result, and outputting an execution result as the search result to the user terminal.

20. The method according to claim 17, wherein, in the searching, the database is searched for the identification information of the sensor terminal having the supplementary information agreeing with the search condition.
